(19) United States
(12) Patent Application Publication
(10) Pub. No.: US 2015/0379415 A1
(43) Pub. Date: Dec. 31, 2015

(54) SYSTEM AND METHOD FOR PROCESSING A TRANSACTION

(71) Applicant: Tata Consultancy Services Limited, Mumbai (IN)

(72) Inventors: Dipti Mohan FONDEKAR, Mumbai (IN); Mahesh KSHIRSAGAR, Mumbai (IN); Rajashree DAS, Mumbai (IN); Sheela Vinayak BHAT, Mumbai (IN)

(73) Assignee: Tata Consultancy Services Limited

(21) Appl. No.: 14/663,501

(22) Filed: Mar. 20, 2015

(30) Foreign Application Priority Data
Jun. 26, 2014 (IN) 2075/MUM/2014

(51) Int. Cl. G06N 5/04

(52) U.S. Cl. CPC G06N 5/045

(57) ABSTRACT

Disclosed is a system and method for processing a transaction. The method comprises receiving an input data from a user. The input data is associated with the transaction. The method further comprises creating a decision tree or a decision table based upon the input data and pre-defined rules. The decision tree comprises a parent node and a child node. The parent node and the child node comprise a first question and a second question respectively presented to the user. The decision table comprises a plurality of criteria/conditions being presented to the user. For each criteria/condition, a conditional response is received from the user. The method further comprises processing the transaction by identifying a solution, stored in a database, based on the decision tree or the decision table.

### PRIORITY CLAIM

The U.S. patent application claims the benefit of priority under 35 U.S.C. §119 to India Patent Application No. 2075/MUM/2014, filed on Jun. 26, 2014. The aforementioned application is incorporated herein by reference in its entirety.

### TECHNICAL FIELD

The present disclosure in general relates to processing of a transaction. More particularly, the present disclosure relates to a system and method for processing the transaction to identify a solution.

### BACKGROUND

Consumers/users/cardholders and service establishments are familiar with issuers of credit cards. The issuers of the credit cards may include Visa®, MasterCard®, and Amex®. Each of the issuers may have their own operating rules and regulations by which consumers and service establishments have to abide. The credit cards may be used at service establishments such as automated teller machines (ATM), point of sale (POS), and instances when no card is required during the transaction such as purchases over the Internet. The issuers may have entered into agreements with the service establishments to accept the credit cards from the users/cardholders to charge for purchase of goods and services or for cash access. Occasionally, the consumers/users/cardholders may receive unsatisfactory goods or services from the service establishments. The users/cardholders may be involved in a dispute with respect to the transaction over price with the service establishments. Further, the service establishments may have failed to comply with the regulations and/or terms of the credit card acceptance agreement with the issuer. In general, the user/cardholder may notify the issuer about the dispute with respect to the transaction with the service establishments. The issuer may begin a resolution process with the user/cardholder.

In one example, in order to process the transaction, the user/cardholder may contact the issuer by filing a request regarding one or more debit items on their credit card. In general, the user/cardholder may request for a chargeback. A typical chargeback is a reversal of a credit transaction which may be charged-back to the acquirer or user/cardholder from the issuer. In other words, the chargeback is the reversal of the financial liability in whole or part of a particular transaction by the card issuer.

The issuers of the credit card may have guidelines which provide rules for processing the request for the chargeback or other disputes. In general, the guidelines to provide a solution to the transaction comprises a set of reason code/resultant or custom procedural code/key field values/resultant value. The code/resultant or custom procedural code/key field values/resultant value may specify steps to be taken for a particular transaction. The process of the chargeback or the other disputes requires identifying the reason code/resultant or custom procedural code/key field values/resultant value that may be appropriate for the transaction. Selection of the reason code/resultant or custom procedural code/key field values/resultant value that are not relevant to the transaction may lead to financial loss to the issuer, customer dissatisfaction and adverse impact to the issuer.

In order to process the transaction, for instance, credit card chargeback, traditionally, the issuer may have to investigate and choose the reason code/resultant that may be relevant to the transaction. However, with the guidelines being revised regularly and becoming complex for interpreting, the time required to process the chargeback or other transaction disputes may increase. Further, manual processing to identify the reason code/resultant for the transaction is time consuming and may be prone to errors.

### SUMMARY

This summary is provided to introduce concepts related to systems and methods for processing a transaction and the concepts are further described below in the detailed description. This summary is not intended to identify essential features of the claimed subject matter nor is it intended for use in determining or limiting the scope of the claimed subject matter.

In one implementation, a method for processing a transaction is disclosed. The method comprises receiving, by a processor, an input data from a user. The input data is associated with the transaction. The method further comprises creating, by the processor, a decision tree or a decision table based upon the input data and pre-defined rules. The decision tree comprises a parent node and a child node. The parent node and the child node comprise a first question and a second question respectively presented to the user. The second question is dependent on a response received, from the user, corresponding to the first question. The decision table comprises a plurality of criteria/conditions being presented to the user. For each criteria/condition, a conditional response is received from the user. The conditional response indicates a criteria/condition being satisfied by the user. The method further comprises processing, by the processor, the transaction by identifying a solution, stored in a database, based on the decision tree or the decision table.

In one implementation, a system for processing a transaction is disclosed. The system comprises a processor and a memory coupled to the processor. The processor executes a plurality of modules stored in the memory. The plurality of modules comprises a receiving module to receive an input data from a user. The input data is associated with the transaction. The plurality of modules further comprises a creating module to create a decision tree or a decision table based upon the input data and pre-defined rules. The decision tree comprises a parent node and a child node. The parent node and the child node comprise a first question and a second question respectively presented to the user. The second question is dependent on a response received, from the user, corresponding to the first question. The decision table comprises a plurality of criteria/conditions being presented to the user. For each criteria/condition, a conditional response is received from the user. The conditional response indicates a criteria/condition being satisfied by the user. The plurality of modules further comprises a processing module to process the transaction to identify a solution, stored in a database, based on the decision tree or the decision table.

In one implementation, a non-transitory computer readable medium embodying a program executable in a computing device for processing a transaction is disclosed. The program comprises a program code for receiving an input data from a user. The input data is associated with the transaction. The program further comprises a program code for creating a decision tree or a decision table based upon the input data and pre-defined rules. The decision tree comprises a parent node and a child node. The parent node and the child node comprise a first question and a second question respectively presented to the user. The second question is dependent on a response received, from the user, corresponding to the first question. The decision table comprises a plurality of criteria/conditions being presented to the user. For each criteria/condition, a conditional response is received from the user, and the conditional response indicates a criteria/condition being satisfied. The program further comprises a program code for processing the transaction to identify a solution, stored in a database, based on the decision tree or the decision table.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for processing a transaction, in accordance with an embodiment of the present disclosure.

FIG. 2 illustrates the system, in accordance with an embodiment of the present disclosure.

FIG. 3 illustrates a method for creating a decision tree, in accordance with an embodiment of the present disclosure

FIG. 4 illustrates a method for processing a transaction, in accordance with an embodiment of the present disclosure.

### DETAILED DESCRIPTION

The present disclosure relates to systems and method for processing a transaction. An input data associated with the transaction may be received from a user/cardholder. The input data may correspond to a category of the transaction. The category may comprise the transaction being taken place while the user is availing a service, or the transaction made at a merchant location, or a transaction associated with an unauthorised transaction. The system may receive the input data and may present a question or conditions to the user/cardholder. A decision tree or a decision table may be created based upon the input data and pre-defined rules. The decision tree may comprise a parent node and a child node. The parent node and the child node may comprise a first question and a second question respectively presented to the user/cardholder. The second question may be dependent on a response received, from the user/cardholder, corresponding to the first question. The decision table comprises a plurality of criteria/conditions being presented to the user. For each criteria/condition, a conditional response is received from the user, and the conditional response indicates a criteria/condition being satisfied.

Based on the questions presented to the user/cardholder and the responses received for the questions, the transaction may be processed to identify a solution. Similarly, based on the plurality of criteria/conditions being presented to the user and the conditional response received for the plurality of criteria/conditions, the transaction may be processed to identify the solution when the decision table is created. The solution may be identified from a database. The solution may be stored in the database based on the decision tree or the decision table.

While aspects of described system and method for processing a transaction may be implemented in any number of different computing systems, environments, and/or configurations, the embodiments are described in the context of the following exemplary system.

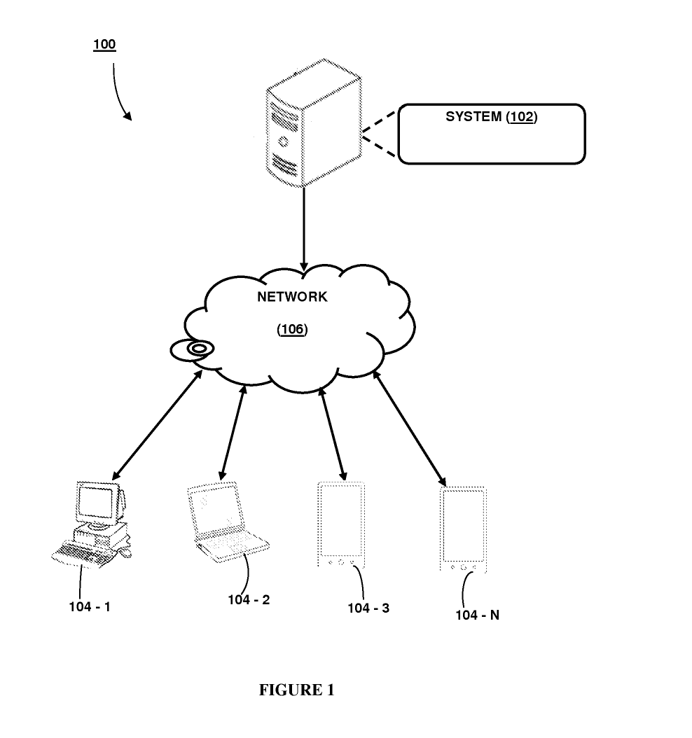

Referring now to FIG. 1, a network implementation 100 of a system 102 for processing a transaction is illustrated, in accordance with an embodiment of the present disclosure. The system 102 may receive an input data associated with the transaction from a user/cardholder. Based on the input data and pre-defined rules, the system 102 may create a decision tree or a decision table. The system 102 may create the decision tree by using a parent node and a child node. The parent node and the child node may comprise a first question and a second question respectively presented to the user/cardholder. Based on the response for the first question, the system 102 may present the second question to the user/cardholder. The system 102 may create the decision table comprising a plurality of criteria/conditions being presented to the user. For each criteria/condition, a conditional response is received from the user, and the conditional response indicates a criteria/condition being satisfied. The system 102 may process the transaction to identify a solution, stored in a database, based on the decision tree or the decision table.

Although the present disclosure is explained by considering a scenario that the system 102 is implemented as an application on a server. It may be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

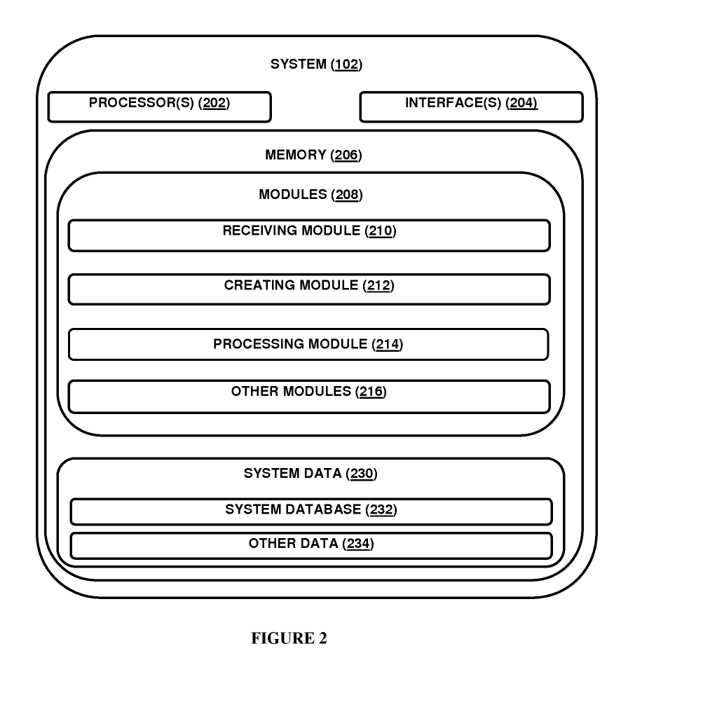

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and system data 230.

The modules 208 include routines, programs, objects, components, data structures, etc., which perform particular tasks or implement particular abstract data types. In one implementation, the modules 208 may include a receiving module 210, a creating module 212, a processing module 214, and other modules 216. The other modules 216 may include programs or coded instructions that supplement applications and functions of the system 102.

The system data 230, amongst other things, serves as a repository for storing data processed, received, and generated by one or more of the modules 208. The system data 230 may also include a system database 232 and other data 234. The other data 234 may include data generated as a result of the execution of one or more modules in the other modules 216.

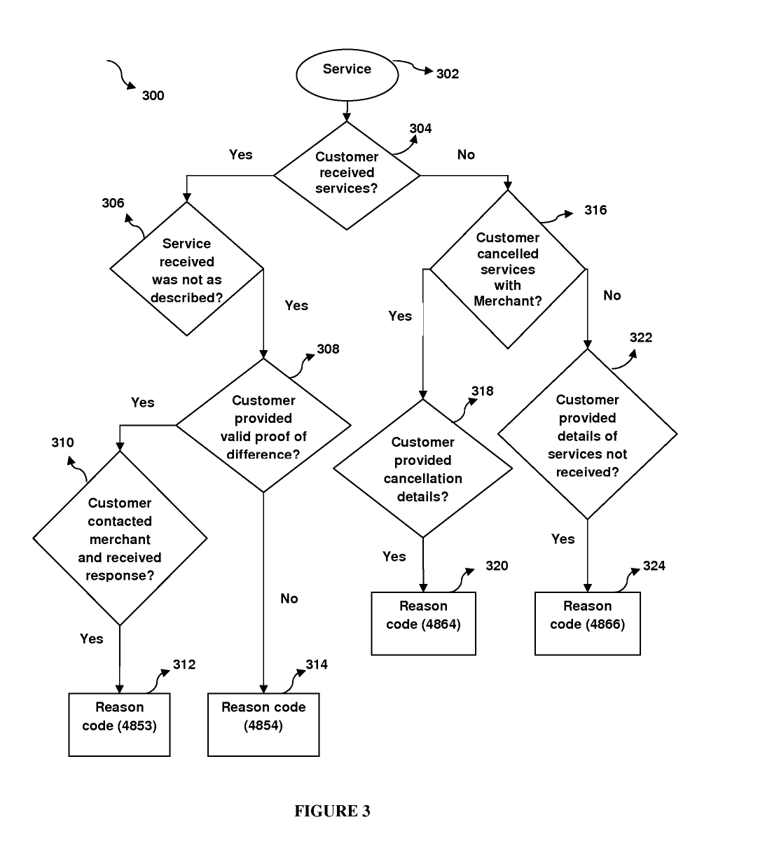

In one implementation, at first, a user may use the client device 104 to access the system 102 via the I/O interface 204. The working of the system 102 may be explained in detail using FIG. 2, and FIG. 3 explained below. The system 102 may be used for processing a transaction. The transaction may be related to any payment type such as credit cards, debit cards, and pin debit cards. Further, the transaction may takes place at an Automated Clearing House (ACH), or at an Automated Teller Machine (ATM), or payments made on internet, or at Point of sale (POS), and other types of financial transactions or non-financial transactions.

Typically, the transaction may begin when a user/cardholder utilizes the credit card. In one example, the user/cardholder may make an inquiry about the validity of the financial transaction which may appear on statement for the credit card. The inquiry may generally be directed to an issuer of the credit card. In one example, the issuer may include but not limited to Visa®, or MasterCard®, or Amex®. It is to be understood that the user/cardholder may enquire the issuer in a number of ways. For example, the user/cardholder may contact the issuer to report the transaction via telephone, written correspondence, or electronic communications such as, e-mail. The issuer may, in turn, communicate with the user via the system 102.

In order to process the transaction associated with the financial transaction or the non-financial transaction, the system 102, at first, may receive an input data from the user/cardholder. Specifically, in the present implementation, the input data may be received by the receiving module 210. The input data may be associated with the transaction. The input data may comprise at least one of an unauthorized transaction, or a merchandise transaction, or a service. In one example, the input data may relate to the financial transaction pertaining to the service that the user/cardholder may have intended to receive from a service provider. In another example, the input data may relate to the financial transaction at a merchant location for purchase of goods or availing services.

It is to be understood that the input data related to the transaction may be collected from the user/cardholder by the receiving module 210 in a number of ways. For example, certain information may be acquired through various methods relating to the user/cardholder and the transaction. In one example, the receiving module 210 may receive the input data via an Interactive Voice Response (IVR) system. The receiving module 210 may obtain the information required to process the transaction including, for example, the credit card number. If the receiving module 210 receives the input data via the IVR system, the IVR system may request the user to provide the information such the credit card number, a password, or other unique identification, and a verification number.

The receiving module 210 may receive the input data associated with the user/cardholder, for the financial transaction at issue, and the merchant. It is to be understood that each of the financial transaction performed using the credit card may be assigned a unique identification number. Further, the financial transaction may be identified by amount and/or the date of the financial transaction. Similarly, non-financial transactions may be identified by a type of goods or services availed by the user/cardholder.

In order to process the transaction, the receiving module 210 may receive the input data from the user/cardholder. The input data received may contain the financial transaction, the merchant's identification number, the date of the financial transaction, the amount of the transaction, or other relevant information to determine the financial transaction. In order to receive the above input data, the receiving module 210 may receive the information by presenting a questionnaire to the user/cardholder. The receiving module 210 may present a question related to the unique identification number assigned to the financial transaction in the dispute with respect to the transaction. Further, the receiving module 210 may present a question related to a dispute with respect to the transaction. For example, the transaction may relate to the credit card charge-back processing, or a securities dispute.

After receiving the input data from the user/cardholder, the system 102 may employ the creating module 212 to create a decision tree or a decision table based upon the input data and the pre-defined rules. Based on the category of the transaction, the user/cardholder may select one of the decision tree and the decision table to identify a solution using the system 102. When the user/cardholder selects the decision tree based on the input data, the system 102 may employ the creating module 212 to create the decision tree. The decision tree may comprise a parent node and a child node. The parent node and the child node may comprise a first question and a second question respectively presented to the user/cardholder. The questions may be presented to the user/card holder in order to identify a solution for the transaction. In order to identify the solution for the transaction, the questions may be presented to the user/cardholder until the solution may be identified based on the pre-defined rules.

Similarly, when the user selects the decision table based on the input data, the system 102 may employ the creating module 212 to create the decision table. The decision table may comprise a plurality of criteria/conditions being presented to the user/cardholder. For each criteria/condition, a conditional response may be received from the user/cardholder. The conditional response may indicate a criteria/condition being satisfied by the user/cardholder.

The solution may comprise a reason code/resultant or a custom procedural code/key field values/resultant value of the transaction. The solution may be a code, such as a number, a letter or an alpha-numeric symbol. In one example, the solution may indicate a reason for the charge-back corresponding to the transaction. In one example, the solution may indicate that the user/cardholder may be dissatisfied with a previously purchased product or service. Further, the solution may indicate that the user/cardholder may not have ordered the product or service. In another example, the solution may indicate that a purchasing card association or the issuer charged for a particular transaction, because the merchant failed to clear the transaction in a timely manner. For example, the solution—the reason code/resultant 30, may indicate that services not provided or merchandise not received. In yet another example, the reason code/resultant 41 may indicate cancelled recurring transaction.

In order to identify the solution for the transaction when the decision tree is selected, the questions may be presented to the user/cardholder. For example, for the input data related to the service, the user/cardholder may be presented with the questions to identify causes or reasons for the transaction. In one example, the question may include—Is the dispute with respect to the transaction related to unauthorized. In another example, the question may include—Did customer disputes the charge for credit is due from the merchant. In another example, the question may include—Did customer disputes the charge as credit posted as sale. Based on the response received from the user for the question, the solution indicating the reason for the transaction may be identified and presented to the user/cardholder. In one embodiment, the solution may be identified and retrieved from the system database 232 based on the decision tree or the decision table.

Similarly, for creating the decision table, the plurality of criteria/conditions may be presented to the user. For example, for the input data related to the service, the user/cardholder may be presented with the conditions to identify causes or reasons for the transaction. In one example, the criteria for the transaction may include—Does the transaction belongs to home use. In one example, the condition may include—does the transaction amount is above $135. In another example, the condition may include—does a proof in a paper format state that the transaction is a permanent use. For the conditions presented to the user, a conditional response may be received by the creating module 212. In one example, the conditional response may include a yes or a no from the user/cardholder. Based on the conditional response received from the user for the criteria/conditions, the solution indicating the reason for the transaction may be identified in the system database 232. The solution identified may be retrieved and presented to the user/cardholder.

In order to create the decision tree, the questions may be presented to the user/cardholder based on the input data and the pre-defined rules. The pre-defined rules may comprise rules and regulations the issuer of the credit card may provide by which the user/cardholder and service establishments may have to abide. The pre-defined rules may be defined by the issuer to identify the solution for the transaction. The pre-defined rules may facilitate in identifying authenticity of the financial transaction so as to process or to cancel the transaction. The pre-defined rules may be stored in the system database 232. In one example, consider the pre-defined rules may correspond to the chargeback process for financial transaction. The pre-defined rules may include verification of the transaction. The verification may comprise identification of the unique identification number of the transaction. In order to verify status of the transaction, the system 102 may use the pre-defined rules to determine whether the transaction is eligible for providing a solution or not. In another example, the pre-defined rules may include adjudicating the transaction based on the documentary evidence provided by the user/cardholder. In another example, the pre-defined rules may include rules comprising the issuer shall not initiate the reason code/resultant for disputes relating to airline dispute.

In one embodiment, the pre-defined rules may be customized for a particular merchant, or for the issuer. For example, the issuer such as Visa® or MasterCard® may have different pre-defined rules for processing the transaction. In one example, if the pre-defined rules are changed by the issuer, the system 102 may identify and retrieve the appropriate rules to apply for the transaction. After retrieving the applicable pre-defined rules, the system 102 may apply the pre-defined rules to process the transaction.

The pre-defined rules may determine whether to grant reversal of the financial transaction, or partial reversal of the financial transaction, or to cancel the transaction initiated by the user/cardholder. In one embodiment, the pre-defined rules may determine the appropriate course of action for the transaction. When the decision tree is selected by the user/cardholder, the creating module 212 may create the child node in the decision tree based on the response from the user/cardholder corresponding to the first question by applying the pre-defined rules. In other words, the first question may be presented to the user/cardholder based on the input data and the pre-defined rules. The user/cardholder may respond to the first question either by agreeing to the first question or by disagreeing to the first question. The user/cardholder may respond to the question via the I/O interface 204. The user/cardholder may respond the question in a number of ways. The creating module 212 may present the questions using radio buttons on the I/O interface 204. The radio buttons may comprise two radio buttons having an option for user/cardholder to select either agreeing or disagreeing to the question. For example, the user/cardholder may select one of the two radio buttons presented to respond to the question presented. Further, the user/cardholder may respond by selecting one of multiple radio buttons presented on the I/O interface 204. It is to be understood that use of other means such as check box, for receiving the response from the user/cardholder may be obvious to a person skilled in the art.

Based on the response to the first question and the pre-defined rules, the second question may be presented to the user/cardholder. For example, the first question may include—Did the customer receive the service. The user/cardholder may respond to the first question by agreeing to receive the service. Further, based on the pre-defined rules and the response, a second question—Did the customer/user/cardholder state that the service received was not as described may be presented to the user/cardholder. In another example, consider that the input data comprises the merchandise transaction as the transaction. The first question may include—Did the customer/user/cardholder receive service from the merchandise. Consider that the user/cardholder responds by disagreeing to the receiving the merchandise. Based on the pre-defined rules and the response, a second question—Did the customer/user/cardholder provide with the expected date to receive merchandise and shipment of the merchandise delivered to the customer may be presented to the user/cardholder.

The creation of the decision tree may be explained as an example with the help of FIG. 3. The decision tree may be created using the input data, for example, the service as shown at step 302. At first, as shown at step 304, the first question—did the customer receive the service may be presented to the user/cardholder based on the input data and the pre-defined rules. The user/cardholder may respond to the first question by agreeing to receive the service. Based on the response and the pre-defined rules, the second question—did the service received was not as described may be presented to the user/cardholder, as shown at step 306.

Based on the response received for the question presented at step 306, the decision tree may be further drilled down to identify the solution. Subsequent to receiving the response for the step 306, the question presented at step 306 may become the parent node for the successive child node, as shown at step 308. In other words, the step 306 may become the first question in the decision tree. Based on the response for the step 306, the child node i.e. step 308 may be presented. The question at step 308 may be presented as—did the customer provide valid proof of difference in the financial transaction. In one example, if the user/cardholder response does not comply with the pre-defined rules as defined by the issuer, the transaction may be processed to identify the solution. The solution may be retrieved from the system database 232 by the processing module 214. In one example, the solution i.e. reason code/resultant 4854, as shown at step 314, may be retrieved from the system database 232 for the decision tree, i.e. 304-306-308-314. The reason code/resultant 4854 may comprise a description indicating solution to the transaction. For example, the reason code/resultant 4854 may include—proceed with reversal of the financial transaction to the user/cardholder.

Similarly, for the question presented at step 308, consider the user/cardholder agreed to the question. The question—did customer contacted merchant and received response, as shown at step 310, may be presented to the user/cardholder, as the second question, based on the response to the question at step 308. Further, consider the response satisfies the criteria as may be defined in the pre-defined rules. The processing module 214 may retrieve the solution, i.e. reason code/resultant from the system database 232. In one example, for the decision tree i.e. 304-306-308-310-312, the reason code/resultant 4853 may be retrieved from the system database 232. For example, the reason code/resultant 4853 may include—request the customer to contact the merchant for verifying the financial transaction.

Referring back to step 304, consider the user/cardholder responds by disagreeing to the first question. The question—did customer cancelled services with merchant may be presented to the user/cardholder as the second question, as shown at step 316. At step 318, the second question—did customer provide cancellation details may be presented based on the response for the first question at step 316. Further, consider the response satisfies the criteria as may be defined in the pre-defined rules. The processing module 214 may identify and retrieve the solution, i.e. the reason code/resultant from the system database 232. In one example, for the decision tree 304-316-318-320, the reason code/resultant 4864 may be retrieved from the system database 232. For example, the reason code/resultant 4864 may include—request the customer to provide valid proof for the cancellation.

Similarly, at step 322, the second question—did customer provide details of services not received may be presented based on the response for the first question at step 316. As explained above, step 318 and step 322 may become the child nodes for the parent node at step 316 based on the response and the pre-defined rules. After step 322, upon receiving the response and if the response satisfies the criteria as may be defined in the pre-defined rules, the processing module 214 may identify and retrieve the solution, i.e. the reason code/resultant from the system database 232. In one example, for the decision tree 304-316-322-324, the reason code/resultant 4866 may be retrieved from the system database 232.

Although the explanation is provided for identifying the solution, i.e. the reason code/resultant for the transaction related to the service, it is apparent to the skilled in the art to identify the solution for the unauthorized transaction and the merchandise transaction in a similar manner.

In one embodiment, while creating the decision tree, the system 102 may employ the creating module 212 to capture a log of the responses received from the user/cardholder. In order to understand the capturing of the log, Table 1 may be used as an example. Specifically, Table 1 shows the log of the responses received from the user/cardholder while creating the decision tree for the unauthorised transaction to identify the solution, i.e. the reason code/resultant.

TABLE 1
Table 1: Capture a log of the responses received from the user

| | Response |
|---|---|
| Questions | Captured |
| Is the dispute related to unauthorized | Yes |
| Customer disputes the charge for credit is due from the | No |
| merchant | |
| Customer disputes the charge as credit posted as sale | No |
| Customer states that they do not recognize the charge | No |
| Customer disputes the charge for double/multiple billing | No |
| Is the customer disputing the charge as paid by other means | No |
| Is the customer disputing the charge as overbilled | No |
| Is the customer disputing the charge as unauthorized | Yes |
| Is the customer disputing the charge all the charges from | Yes |
| the merchant as unauthorized | |
| Check if the charges are recurring in nature | Yes |
| Check if customer has provided with a valid authorized | Yes |
| statement | |

Reason Code/resultant 4837

Table 1 shows the log of the responses captured for each of the question in the decision tree while processing the transaction to identify the solution, i.e. the reason code/resultant. For example, from the Table 1, the response Yes, for the question—Is the dispute related to unauthorized may be captured in the log. In another example, the response No, for the question customer disputes the charge for credit is due from the merchant may be captured in the log.

Subsequent to capturing the responses for the questions in the log, the creating module 212 may record time taken to create the child node based on the response received from the user/cardholder. In other words, the creating module 212 may record the time between the first question and the second question that may be presented to the user/cardholder. In one example, the time taken to create the second question based on the response for the first question may be 2 minutes. The time taken between the first question and the second question may be shown in Table 2 as an example, Specifically, Table 2 shows the time taken between each question presented and the response received from the user/cardholder.

TABLE 2
Table 2: Time taken between the first question and the second question

| | Response | |
|---|---|---|
| Questions | Captured | Time Taken |
| Is the dispute related to unauthorized | Yes | 1 Min 10 Sec |
| Customer disputes the charge for credit is due from the | No | 1 Min 30 Sec |
| merchant | | |
| Customer disputes the charge as credit posted as sale | No | 1 Min 00 Sec |
| Customer states that they do not recognize the charge | No | 1 Min 05 Sec |
| Customer disputes the charge for double/multiple billing | No | 2 Min 10 Sec |
| Is the customer disputing the charge as paid by other means | No | 1 Min 10 Sec |
| Is the customer disputing the charge as overbilled | No | 1 Min 00 Sec |
| Is the customer disputing the charge as unauthorized | Yes | 0 Min 50 Sec |
| Is the customer disputing the charge all the charges from the | Yes | 1 Min 10 Sec |
| merchant as unauthorized | | |
| Check if the charges are recurring in nature | Yes | 1 Min 20 Sec |
| Check if customer has provided with a valid authorized | Yes | 1 Min 40 Sec |
| statement | | |

After capturing the responses and the time taken in the log, the creating module 212 may identify a number of child nodes that the transaction may have taken in the decision tree to identify the solution. The number of child nodes a decision tree may have taken may be illustrated using FIG. 3 as an example. FIG. 3 shows the number of child nodes processed for the transaction in the decision tree to identify the solution. For example, in order to identify the solution, i.e. reason code/resultant 4853, the number of child nodes that are processed subsequent/successive to the parent node may be calculated. The number of child nodes in the decision tree may be determined for the transaction related to the service for identifying the reason code/resultant. In order to identify the solution i.e. the reason code/resultant 4853, the child nodes in the decision tree may be determined as 5 i.e. 304-306-308-310-312. In another example, for the reason code/resultant 4853, the number of child nodes that are processed subsequent/successive to the parent node may be calculated. In order to identify the solution, i.e. the reason code/resultant 4864, the child nodes in the decision tree may be determined as 4, i.e. 304-316-318-320. Based on the number of child nodes that the decision tree comprises, complexity for reaching the solution may be determined. For example, for the reason code/resultant 4853, consider that the complexity may be determined, as easy, if the number of child nodes is 2, complexity as medium if the number of child nodes is 3 and complexity as high if the number of child nodes is 5. For identifying the solution, i.e. the reason code/resultant 4853, the complexity may be determined as high.

After identifying the solution and complexity, the system 102 may employ the processing module 214 to generate a report comprising the first question, the second question, and the response, corresponding to the decision tree. The report may comprise the log and the complexity for reaching to the solution.

As presented above, when the user selects the decision table based on the input data, the system 102 may employ the creating module 212 to create the decision table. Creation of the decision table may be explained with the help of Table 3. At first, the plurality of criteria/conditions may be presented to the user/cardholder corresponding to the transaction. In one example, the criteria may comprise the transaction being used for home use. In another example, the criteria may comprise the transaction being used for gifting. In one example, the condition may comprise, for the criteria, is the value of the transaction is below $15 or not. In another example, the condition may comprise whether the user/cardholder provided authentic paperwork for the transaction or not.

TABLE 3
Table 3: Creation of the decision table

| Criteria | Condition 1 | Condition 2 | Condition 3 | CPC |
|---|---|---|---|---|
| Low value | Value <$15 | No sample | Non- | 4000C07 |
| | | word | excisable/ | |
| | | stated on | Defra | |
| | | paperwork | | |
| Samples | Value <$135 | Only if | Sample word | 4000C30 |
| Criteria | | consigned to | stated on | |
| | | company | paperwork | |
| Home Use | Value <$135 | Non- | Paperwork | 4000C06 |
| | | Excisable/ | states | |
| | | Non-Defra/ | permanent | |
| | | CMF is | use | |
| | | on SD | | |
| Home Use | Value <$135 | CMF on | Paperwork | 4000C04 |
| | | JQ/Notepad | states | |
| | | specific | permanent | |
| | | | use | |

After presenting the plurality of criteria/conditions to the user/cardholder, for each of the criteria and condition, the creating module 212 may receive the conditional response from the user/cardholder. The conditional response may indicate the criteria/condition being satisfied by the user/cardholder. In one example, the user may provide the conditional response with a Yes indicating the condition being satisfied for the transaction. In another example, the user may provide the conditional response with a No indicating the condition not being satisfied for the transaction.

Based on the transaction, the plurality of conditions may be presented to the user/cardholder as shown in Table 3. For example, one of the conditions may comprise value of the transaction being less than $15 for the criteria low value. Further, a second condition for the transaction may comprise whether sample word is stated on paperwork for the transaction or not. Further, a third condition may comprise whether the transaction is Non-excisable/Defra or not. For the transaction, for each of the condition in the plurality of conditions, the creating module 212 may receive the conditional response. Based on the conditional responses for the plurality of conditions corresponding to the transaction, the processing module 214 may identify the solution for the transaction. For example, the solution may comprise a custom procedural code (CPC)/key field values/resultant value for the transaction based on the decision table. The custom procedural code (CPC)/key field values/resultant value may comprise a code, such as a number, a letter or an alpha-numeric symbol. The custom procedural code (CPC)/key field values/resultant value may indicate the reason for the transaction being processed or not. The transaction may be processed depending on the input data and the pre-defined rules. As explained above, the solution may indicate that the user/cardholder may be dissatisfied with a previously purchased product or service. Further, the solution may indicate that the user/cardholder may not have ordered the product or service.

For the example shown in Table 3, upon receiving the conditional response for each of the criteria/condition of the plurality of criteria/conditions, the system 102 may employ the processing module 214 to identify the solution. The processing module 214 may identify the solution, i.e. custom procedural code (CPC)/key field values/resultant value for the transaction based on the conditional response, the input data and the pre-defined rules. For example, the processing module 214 may identify the solution, i.e. 4000007. The processing module 214 may identify the solution, stored in the database, based on the decision table.

The system 102 may present appropriate questions or criteria/conditions to the user/cardholder and may identify the solution for processing the transaction. The system 102 enables to record the time taken for processing each question using the decision tree.

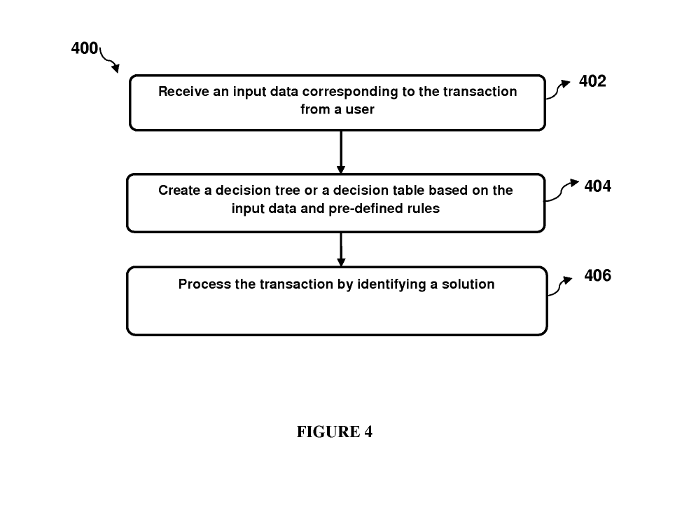

Referring now to FIG. 4, a method 400 for processing a transaction is shown, in accordance with an embodiment of the present disclosure. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described and is not intended to be construed as a limitation, and any number of the described method blocks can be combined in any order to implement the method 400 or alternate methods. Additionally, individual blocks may be deleted from the method 400 without departing from the spirit and scope of the disclosure described herein. Furthermore, the method may be implemented in any suitable hardware, software, firmware, or combination thereof. However, for ease of explanation, in the embodiments described below, the method 400 may be implemented in the above-described system 102.

At step 402, an input data from a user/cardholder may be received. The input data may be associated with the transaction. In one implementation, the input data may be received by the receiving module 210.

At step 404, a decision tree or a decision table may be created. The decision tree and the decision table may be created based upon the input data and pre-defined rules. The decision tree may comprise a parent node and a child node. The parent node and the child node may comprise a first question and a second question respectively presented to the user. The second question maybe dependent on a response received, from the user, corresponding to the first question. The decision table may comprise a plurality of criteria/conditions being presented to the user. For each criteria/condition, a conditional response may be received from the user. The conditional response may indicate a criteria/condition being satisfied by the user. In one implementation, the decision tree and the decision table may be created by the creating module 212.

At step 406, the transaction may be processed to identify a solution, stored in a database, based on the decision tree or the decision table. In one implementation, the solution may be identified by the processing module 214.

Although implementations of system and method for processing a transaction have been described in language specific to structural features and/or methods, it is to be understood that the appended claims are not necessarily limited to the specific features or methods described. Rather, the specific features and methods are disclosed as examples of implementations for processing a transaction.

What is claimed is:

1. A method for processing a transaction, the method comprising:
receiving, by a processor, an input data from a user, wherein the input data is associated with a transaction;
creating, by the processor, a decision tree or a decision table based upon the input data and pre-defined rules, wherein the decision tree comprises a parent node and a child node, wherein the parent node and the child node comprise a first question and a second question respectively presented to the user, wherein the second question is dependent on a response to the first question received from the user, and wherein the decision table comprises a plurality of criteria/conditions being presented to the user, wherein a conditional response is received from the user for each criteria/condition, and wherein the conditional response indicates a criteria/condition being satisfied; and
processing, by the processor, the transaction by identifying a solution stored in a database based on the decision tree or the decision table.

2. The method of claim 1, wherein the transaction is at least one of credit card chargeback process, or a securities dispute.

3. The method of claim 1, wherein the input data comprises at least one of an unauthorized transaction, a merchandise transaction, or a service.

4. The method of claim 1, further comprising capturing a log of the response to the first question received from the user.

5. The method of claim 4, wherein the log comprises an amount time taken to create the child node based on the response to the first question received from the user.

6. The method of claim 1, wherein the solution comprises:
a reason code/resultant for the decision tree, and
a custom procedural code/key field values/resultant value of the transaction for the decision table.

7. The method of claim 1, further comprising identifying a number of the child node in the decision tree.

8. The method of claim 1, further comprising generating a report comprising the first question, the second question, and the response to the first question.

9. A system for processing a transaction, the system comprising:
a processor; and
a memory coupled to the processor, wherein the processor executes a plurality of modules stored in the memory, the plurality of modules comprising:
a receiving module to receive an input data from a user, wherein the input data is associated with a transaction;
a creating module to create a decision tree or a decision table based upon the input data and pre-defined rules, wherein the decision tree comprises a parent node and a child node, wherein the parent node and the child node comprise a first question and a second question respectively presented to the user, wherein the second question is dependent on a response to the first question received from the user, and wherein the decision table comprises a plurality of criteria/conditions being presented to the user, wherein a conditional response is received from the user for each criteria/condition, and wherein the conditional response indicates a criteria/condition being satisfied; and
a processing module to process the transaction to identify a solution stored in a database based on the decision tree or the decision table.

10. The system of claim 9, wherein the transaction is at least one of a credit card chargeback process, or a securities dispute.

11. The system of claim 9, wherein the input data comprises at least one of an unauthorized transaction, a merchandise transaction, or a service.

12. The system of claim 9, wherein the creating module captures a log of the response to the first question received from the user.

13. The system of claim 12, wherein the log comprises an amount of time taken to create the child node based on the response to the first question received from the user.

14. The system of claim 9, wherein the solution comprises:
a reason code/resultant value for the decision tree, and
a custom procedural code/key field values/resultant value of the transaction for the decision table.

15. The system of claim 9, wherein the creating module identifies a number of the child node in the decision tree.

16. A non-transitory computer readable medium comprising a program executable by a computing device for processing a transaction, the program comprising:
a program code for receiving an input data from a user, wherein the input data is associated with a transaction;
a program code for creating a decision tree or a decision table based upon the input data and pre-defined rules, wherein the decision tree comprises a parent node and a child node, wherein the parent node and the child node comprise a first question and a second question respectively presented to the user, wherein the second question is dependent on a response to the first question received from the user, and wherein the decision table comprises a plurality of criteria/conditions being presented to the user, wherein a conditional response is received from the user for each criteria/condition, and wherein the conditional response indicates a criteria/condition being satisfied; and
a program code for processing the transaction by identifying a solution, stored in a database, based on the decision tree or the decision table.

17. The medium of claim 16, wherein the solution comprises:
a reason code/resultant value for the decision tree, and
a custom procedural code/key field values/resultant value of the transaction for the decision table.

18. The medium of claim 16, wherein the transaction is at least one of a credit card chargeback process, or a securities dispute.

19. The medium of claim 16, wherein the input data comprises at least one of an unauthorized transaction, a merchandise transaction, or a service.

20. The medium of claim 16, wherein the program code for creating a decision tree or a decision table captures a log of the response to the first question received from the user.
